(19) United States
(12) Patent Application Publication
(10) Pub. No.: US 2025/0212179 A1
(43) Pub. Date: Jun. 26, 2025

(54) TECHNIQUES FOR DELAY-AWARE LOGICAL CHANNEL PRIORITIZATION

(71) Applicant: Lenovo (Singapore) Pte. Ltd., Singapore (SG)

(72) Inventors: Joachim Löhr, Wiesbaden (DE); Hossein Hossein, Dearborn Heights, MI (US)

(21) Appl. No.: 19/000,037

(22) Filed: Dec. 23, 2024

Related U.S. Application Data
(60) Provisional application No. 63/613,953, filed on Dec. 22, 2023.

(51) Int. Cl. H04W 72/02; H04W 28/02

(52) U.S. Cl. CPC H04W 72/02; H04W 28/0278

(57) ABSTRACT

Various aspects of the present disclosure relate to techniques for delay-aware logical channel prioritization. A user equipment (UE) is configured to establish a logical channel based on a received configuration, the configuration comprising a logical channel priority for the logical channel, determine a first parameter associated with data of the logical channel, and calculate a priority value for the data of the logical channel based at least in part on the first parameter and the logical channel priority in response to determining that the first parameter is below a threshold.

### TECHNICAL FIELD

The present disclosure relates to wireless communications, and more specifically to techniques for delay-aware logical channel prioritization.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

Some implementations of the method and apparatuses described herein may establish a logical channel based on a received configuration, the configuration comprising a logical channel priority for the logical channel, receive information for allocating resources for data transmission associated with the logical channel, determine a first parameter associated with data of the logical channel, and calculate a priority value for the data of the logical channel based at least in part on the first parameter and the logical channel priority in response to determining that the first parameter is below a threshold.

Some implementations of the method and apparatuses described herein may determine a logical channel priority for a logical channel, transmit a configuration for establishing the logical channel with a UE, the configuration comprising the logical channel priority, and receive data on the logical channel from the UE based on the logical channel priority.

### BRIEF DESCRIPTION OF THE DRAWINGS

FIG. 1 illustrates an example of a wireless communications system in accordance with aspects of the present disclosure.

FIG. 2 illustrates an example of enhanced logical channel prioritization (LCP) procedure in response to UL grants received within a time window determined based on the time DSR is sent, in accordance with aspects of the present disclosure.

FIG. 3 illustrates an example of triggering DSR, in accordance with aspects of the present disclosure.

FIG. 4 illustrates an example of a UE configured with two logical channels (LCHs), in accordance with aspects of the present disclosure.

FIG. 5 illustrates an example of a multiplexed transport block (TB), in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of a network equipment in accordance with aspects of the present disclosure.

FIG. 9 illustrate a flowcharts of method performed by a UE in accordance with aspects of the present disclosure.

FIG. 10 illustrate a flowcharts of method performed by a network equipment in accordance with aspects of the present disclosure.

### DETAILED DESCRIPTION

Delay status report (DSR) reporting is generally used to notify the gNB scheduler of urgent/delay critical data pending in the UE buffer. A DSR medium access control (MAC) control element (CE) contains the amount of data for which the remaining delay is below a configured threshold. However, since the full buffer status might not be known to the scheduler, e.g., there may be some other higher priority non-urgent data pending in the UE buffer, the uplink (UL) grant issued by the scheduler in response to the reception of a DSR MAC CE may not allow the transmission of the urgent data because the allocated resources are not sufficient to transmit other higher priority data and the delay-critical data. Conventional LCP procedures consider only the LCH priority and not the delay status. Therefore, the UE may transmit higher priority non-urgent/delay-tolerant data instead of the urgent/delay-critical data for an UL grant tailored in accordance with the DSR report.

One possible mapping option for extended reality (XR)-communication may include mapping protocol data unit (PDU) sets of different importance level to the same quality of service (QoS) flow and radio bearer. One example of such a mapping option may be where I-frames and P-frames of a video stream are carried by the same QoS flow/radio bearer.

A QoS flow/radio bearer for XR traffic may carry PDU sets with a different importance level (PSI level), e.g., I-frames and P-frames of a video stream. According to conventional QoS architectures, data packets of a radio bearer experience the same QoS treatment. To handle PDU sets associated with high importance levels, e.g., prioritization of high importance data and discarding of low importance data in case of congestion, new layer 2 procedures/mechanisms are needed.

In one embodiment, the gNB can consider knowledge of PDU set delay in scheduling transmissions, e.g., by giving priority to transmissions close to their delay budget limit, and by not scheduling transmissions (e.g., UL transmissions) exceeding a PDU set delay budget. The UE can also take advantage of such knowledge to conserve the UE's power by determining if an UL transmission (e.g., UL pose, or physical uplink shared channel (PUSCH)) corresponding to a transmission that exceeds its delay budget can be dropped. Additionally, the UE does not need to wait for retransmission of a physical downlink shared channel (PDSCH) that will never occur (e.g., discontinuous reception (DRX) retransmission timers can be stopped). For downlink (DL) transmissions, it is assumed that the gNB is aware of the remaining delay budget of the data pending for transmission, e.g., based on information provided by the session management function (SMF), and takes such knowledge into account in scheduling decisions.

For UL resource allocation, it may be necessary that the UE provide assistance information regarding the remaining delay budget of the data pending in its buffer to the gNB. In one embodiment, the UE provides information on the remaining delay budget of the data for which UL resources are requested. Such assistance information is referred to as delay status reporting (DSR) reporting. In one embodiment, the PDU set delay budget (PSDB) information provided to the RAN is not sufficient. Since the network (NW) is not aware of the exact arrival time of UL data in the buffer and hence can also not be sure about the remaining (valid) time of data pending in the buffer for transmission, the UE provides this information, e.g., the remaining delay information, within the DSR reporting. In one embodiment, a DSR MAC CE is used for XR-specific logical channel groups (LCGs), which includes the amount of data available for transmission and the remaining delay information associated with the reported data.

Furthermore, in one embodiment, threshold-based DSR reporting is supported, e.g., DSR reporting is triggered when the remaining delay of a PDU/PDU set is below a NW configured threshold, which may be configured per LCG.

In one embodiment, PDU set importance (PSI) can be considered for a PDU set that discards the presence of UL congestion. Therefore, in addition to the timer-based discard mechanism within a given packet data convergence protocol (PDCP) entity, a PDCP discarding mechanism based on PSI level is introduced for XR communications.

In one embodiment, the NW controls the PSI-based discarding at the UE in the presence of congestion. To be more specific, the NW explicitly orders the UE to enable/disable PSI-based PDCP discarding, e.g., the NW enables/disables PSI-based discarding, based on detected congestion. In other words, the NW is responsible for the detection of congestion and the UE follows the NW signaling.

In one embodiment, the solutions for PSI-based discarding include two options—timer-based or threshold-based. When the network determines there is congestion, and PSI-based discarding is used, it indicates to the UE to apply PSI-based discarding via dedicated signalling. The two options behave differently when activated. In timer-based, a new discard timer value is set, e.g., a congestion timer value. Congestion timer values may be possible to configure with different values for different PSI levels (otherwise the mechanism would not be PSI-based). In threshold-based, PDU sets that have PSI below the threshold (e.g., as soon as they enter the buffer or directly when the PSI based discarding is activated in the UE) are dropped.

For cases where the UE triggers and transmits a DSR report to make the gNB scheduler aware of urgent/delay critical data pending in the UE buffer, e.g., data for which the associated remaining delay is below a preconfigured threshold, the buffer status conveyed within the DSR includes the data for which the remaining delay is below the threshold. However, since the full buffer status might not be known to the scheduler, e.g., some other higher priority data pending in the UE buffer for which the remaining delay is not larger than the threshold, the UL grant issued by the scheduler in response to the reception of a DSR MAC CE may not allow the transmission of the urgent data because there might be other higher priority data pending in the UE buffer. The current LCP procedure considers only the LCH priority and not the delay status. Accordingly, the UE may transmit higher priority non-urgent/delay-tolerant data instead of the urgent/delay-critical (lower priority) data for an UL grant tailored in accordance to the DSR report.

This disclosure describes solutions that are aimed at maximizing the transmission of delay-critical/urgent data by enhancing the UL scheduling procedure, e.g., the LCP procedure and DSR reporting procedure. In one solution, the LCP procedure considers, in addition to the LCH priority, the delay status of data packets (radio link control (RLC) service data units (SDUs)). This enhanced LCP procedure is applied in certain predefined conditions. In another solution the DSR report is enhanced by conveying buffer size information of high-priority non-urgent data.

Aspects of the present disclosure are described in the context of a wireless communications system.

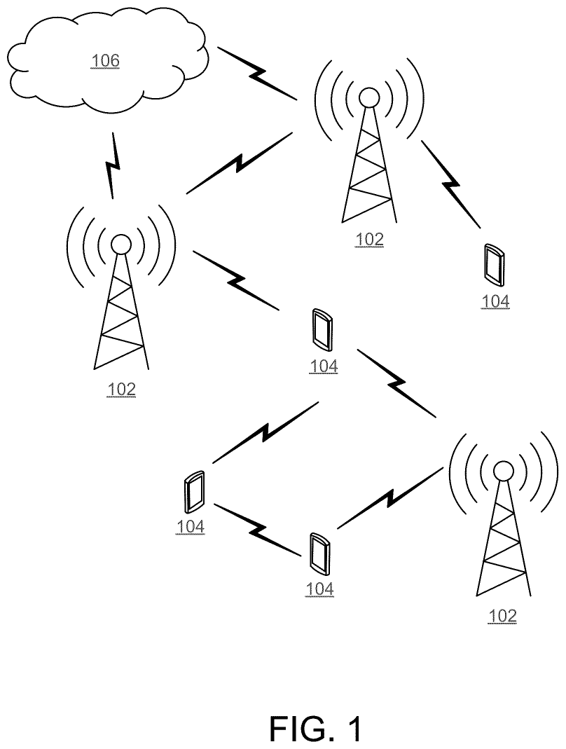

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or TRPs.

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=³) may be associated with a fourth subcarrier spacing (e.g., 120 kHz) and a normal cyclic prefix. A fifth numerology (e.g., μ=⁴) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=³, μ=⁴) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As background, XR may refer to an umbrella term for different types of realities. Virtual reality (VR) is a rendered version of a delivered visual and audio scene. The rendering is designed to mimic the visual and audio sensory stimuli of the real world as naturally as possible to an observer or user as they move within the limits defined by the application. Virtual reality usually, but not necessarily, requires a user to wear a head mounted display (HMD), to completely replace the user's field of view with a simulated visual component, and to wear headphones, to provide the user with the accompanying audio. Some form of head and motion tracking of the user in VR is usually also necessary to allow the simulated visual and audio components to be updated in order to ensure that, from the user's perspective, items and sound sources remain consistent with the user's movements. Additional means to interact with the virtual reality simulation may be provided but are not strictly necessary.

Augmented reality (AR) is when a user is provided with additional information or artificially generated items, or content overlaid upon their current environment. Such additional information or content will usually be visual and/or audible, and their observation of their current environment may be direct, with no intermediate sensing, processing and rendering, or indirect, where their perception of their environment is relayed via sensors and may be enhanced or processed. Mixed reality (MR) is an advanced form of AR where some virtual elements are inserted into the physical scene with the intent to provide the illusion that these elements are part of the real scene.

Extended reality (XR) refers to all real-and-virtual combined environments and human-machine interactions generated by computer technology and wearables. It includes representative forms such as AR, MR and VR and the areas interpolated among them. The levels of virtuality range from partially sensory inputs to fully immersive VR. A key aspect of XR is the extension of human experiences especially relating to the senses of existence (represented by VR) and the acquisition of cognition (represented by AR).

Many of the XR and CG use cases are characterised by quasi-periodic traffic (with possible jitter) with high data rate in DL (i.e., video steam) combined with the frequent UL (i.e., pose/control update) and/or UL video stream. Both DL and UL traffic are also characterized by relatively strict packet delay budget (PDB).

The set of anticipated XR and CG services has a certain variety and characteristics of the data streams (i.e., video) may change “on-the-fly,” while the services are running over NR. Therefore, additional information on the running services from higher layers, e.g. the QoS flow association, frame-level QoS, PDU set-based QoS, XR specific QoS etc, may be beneficial to facilitate informed choices of radio parameters. It is clear that XR application awareness by UE and gNB would improve the user experience, improve the NR system capacity in supporting XR services, and reduce the UE power consumption.

An Application Data Unit (ADU) or PDU set is the smallest unit of data that can be processed independently by an application (such as processing for handling out-of-order traffic data). A video frame can be an I-frame, P-frame, or can be composed of I-slices, and/or P-slices. I-frames/I-slices are more important and larger than P-frames/P-slices. A PDU set can be one or more I-slices, P-slices, I-frame, P-frame, or a combination of those.

A service-oriented design considering XR traffic characteristics (e.g., (a) variable packet arrival rate: packets coming at 30-120 frames/second with some jitter, (b) packets having variable and large packet size, (c) B/P-frames being dependent on I-frames, (d) presence of multiple traffic/data flows such as pose and video scene in uplink) can enable more efficient (e.g., in terms of satisfying XR service requirements for a greater number of UEs, or in terms of UE power saving) XR service delivery.

The latency requirement of XR traffic in RAN side (i.e., air interface) is modelled as packet delay budget (PDB). The PDB is a limited time budget for a packet to be transmitted over the air from a gNB to a UE.

For a given packet, the delay of the packet incurred in air interface is measured from the time that the packet arrives at the gNB to the time that it is successfully transferred to the UE. If the delay is larger than a given PDB for the packet, then, the packet is said to violate PDB, otherwise the packet is said to be successfully delivered.

The value of PDB may vary for different applications and traffic types, which can be 10-20 ms depending on the application (see TR 26.926, incorporated herein by reference).

5G arrival time of data bursts on the downlink can be quasi periodic i.e., periodic with jitter. Some of the factors leading to jitter in burst arrival include varying server render time, encoder time, RTP packetization time, link between server and 5G gateway etc. 3GPP agreed simulation assumptions for XR evaluation model DL traffic arrival jitter using truncated Gaussian distribution with mean: 0 ms, std. .dev: 2 ms, range: [−4 ms, 4 ms](baseline), [−5 ms, 5 ms](optional).

Applications can have a certain delay requirement on a PDU set, that may not be adequately translated into packet delay budget requirements. For example, if the PSDB is 10 ms, then PDB can be set to 10 ms only if all packets of the PDU set arrive at the 5G system at the same time. If the packets are spread out, then the PDU set delay budget is measured either in terms of the arrival of the first packet of the PU set or the last packet of the PDU set. In either case, a given PSDB will result in different PDB requirements on different packets of the PDU set. It is observed that specifying the PSDB to the 5G system can be beneficial.

If the scheduler, and/or the UE, is aware of delay budgets for a packet/ADU, the gNB can take this knowledge into account in scheduling transmissions, e.g., by giving priority to transmissions close to their delay budget limit, and by not scheduling (e.g., UL) transmissions; the UE can also take advantage of such knowledge to determine 1) if an UL transmission (e.g., physical uplink control channel (PUCCH) in response to PDSCH, UL pose, or PUSCH) corresponding to a transmission that exceeds its delay budget can be dropped (additionally, no need to wait for re-transmission of a PDSCH and no need to keep the erroneously received PDSCH in buffer for soft combining with a re-transmission that never occurs) or 2) how much of its channel occupancy time in case of using unlicensed spectrum can be shared with the gNB.

The remaining delay budget 1) for a DL transmission can be indicated to the UE in a DCI (e.g., for a packet of a video frame/slice/ADU) or via a MAC-CE (e.g., for an ADU/video frame/slice) and 2) for an UL transmission can be indicated to the gNB via an UL transmission such as UCI, PUSCH transmission, etc.

XR-Awareness relies on QoS flows, PDU Sets, Data Bursts and traffic assistance information (see TS 23.501, incorporated herein by reference). To enable PDU Set based QoS handling, PDU Set QoS Parameters may be provided by the SMF to the gNB as part of the QoS profile of the QoS flow (at least one of them shall be provided).

PDSB, as defined in TS 23.501, upper bound for the duration between the reception time of the first PDU (at the UPF for DL, at the UE for UL) and the time when all PDUs of a PDU Set have been successfully received (at the UE in DL, at the UPF in UL). A QoS Flow is associated with only one PSDB, and when available, it applies to both DL and UL and supersedes the PDB of the QoS flow.

PDU Set Error Rate (PSER), as defined in TS 23.501, upper bound for a rate of non-congestion related PDU Set losses between RAN and the UE. A QoS Flow is associated with only one PSER, and when available, it applies to both DL and UL and supersedes the PER of the QoS flow.

PDU Set Integrated Handling Information (PSIHI) indicates whether all PDUs of the PDU Set are needed for the usage of PDU Set by application layer, as defined in TS 23.501.

In addition, the UPF can identify PDUs that belong to PDU Sets, and may determine the following PDU Set Information, which it sends to the gNB in the GTP-U header—PDU Set Sequence Number, Indication of End PDU of the PDU Set, PDU Sequence Number within a PDU Set, PDU Set Size in bytes, PSI, which identifies the relative importance of a PDU Set compared to other PDU Sets within the same QoS Flow.

Traffic assistance information may also be provided by 5GC to the gNB. In one embodiment, via TSCAI (for both GBR and non-GBR QoS flows), UL and/or DL Periodicity and N6 Jitter Information (i.e. between UPF and Data Network) associated with the DL Periodicity. In one embodiment, indication of End of Data Burst in the GTP-U header of the last PDU in downlink. In the uplink, the UE needs to be able to identify PDU Sets and Data Bursts dynamically, including PSI. How this is done is left up to UE implementation.

Regarding jitter aspects of XR, the packet arrival rate is determined by the frame generation rate, e.g., 60 fps. Accordingly, the average packet arrival periodicity is given by the inverse of the frame rate, e.g., 16.6667 ms=1/60 fps. The periodic arrival without jitter gives the arrival time at gNB for packet with index k (=1,2,3 . . . ) as k/F*1000 [ms], where F is the given frame generation rates (per second). Note that this periodic packet arrival implicitly assumes fixed delay contributed from network side including fixed video encoding time, fixed network transfer delay, etc.

However, in a real system, the varying frame encoding delay and network transfer time introduces jitter in packet arrival time at gNB which. In this model, the jitter is modelled as a random variable added on top of periodic arrivals. The jitter follows truncated Gaussian distribution with following statistical parameters shown in Table 1.

TABLE 1
Statistical parameters for jitter

| | | Baseline value | Optional value |
|---|---|---|---|
| Parameter | unit | for evaluation | for evaluation |
| Mean | ms | 0 | |
| STD | ms | 2 | |
| Truncation range | ms | [−4, 4] | [−5, 5] |

Note that the given parameter values and considered frame generation rates (60 or 120 in this model) ensure that packet arrivals are in order (i.e., arrival time of a next packet is always larger than that of the previous packet). Thus, the periodic arrival with jitter gives the arrival time for packet with index k (=1,2,3 . . . ) as offset+k/F*1000+J [ms], where F is the given frame generation rates (per second), and J is a random variable capturing jitter. Note that actual traffic arrival timing of traffic for each UE could be shifted by the UE specific arbitrary offset. It is also noted that throughout this disclosure, the term remaining relay refers to the remaining time until the associated PDCP discard timer of a PDU SDU/PDU expires.

According to one embodiment, UE prioritizes the transmission of delay-critical data during the LCP procedure for cases when a DSR report was sent which reported the delay-critical data which is of lower priority than other non-delay critical data pending in the UE for transmission. According to the current LCP procedure, UE maximizes the transmission of high priority data, i.e. LCH priority is a main factor, which, to a large extent, determines the data being multiplexed in a TB. Hence it may happen that UE can't transmit the urgent delay-critical data on the UL resources allocated by the gNB in response to the reception of the DSR MAC CE, since gNB might not be aware of the other high priority data sitting in UE's buffer (DSR includes only the amount of delay-critical data). According to one implementation of this embodiment, UE/MAC prioritizes the transmission of delay-critical data during LCP procedure for a UL grant sent in response/after having transmitted the DSR. In one example UE prioritizes the delay-critical data over higher-priority data, if any, pending in UE's buffer for transmission. According to one specific implementation of the embodiment, UE first multiplexes the delay-critical data (data, which was reported in a DSR) into a TB before multiplexing data of any other LCH. In one example, UE first multiplexes the delay-critical data into the TB and if there are any remaining resources in the allocated UL resources, UE performs the legacy LCP procedure for the remaining UL resources/remaining space in the TB.

In one example, UE/MAC applies an enhanced LCP procedure where, in a first step, UL resources are assigned to the LCHs carrying delay-critical data, e.g., reported in a DSR MAC CE. If there are some remaining UL resources—after the first step—the remaining UL resources are assigned to the (other) LCHs according to the legacy LCP procedure. The enhanced LCP procedure is comprised of three steps/rounds, e.g., first step satisfying the delay-critical data, second step satisfying the PBR requirements of the LCH, and third step filling the remaining UL resources in strict priority order.

According to one implementation of the embodiment, UE considers the LCH priority configured for a LCH for determining the order in which data is multiplexed into a TB for cases when there is delay-critical data of more than one LCH pending for transmission during LCP procedure. UE prioritizes critical data e.g. over higher priority, but not delay-critical data and in addition some prioritization among the delay-critical data is done based on the configured LCH priority.

According to one implementation of the embodiment, one or more conditions may be defined which determine whether UE/MAC should prioritize delay-critical data during LCP procedure, e.g. regardless of the LCH priority. According to one implementation of the embodiment, UE/MAC prioritizes delay-critical data during LCP procedure when the remaining delay associated with the delay-critical data is below a preconfigured threshold. In one example, the threshold is equal to or larger than the UE processing time T_{proc,2}, i.e. minimum time for UE to process an UL grant and generate the corresponding TB.

According to one implementation of the embodiment, UE/MAC prioritizes delay-critical data during LCP procedure when the remaining delay associated with the delay-critical data is below a preconfigured threshold and the remaining delay associated with higher priority data (data with a higher LCH priority compared to the delay-critical data) is greater than another preconfigured threshold.

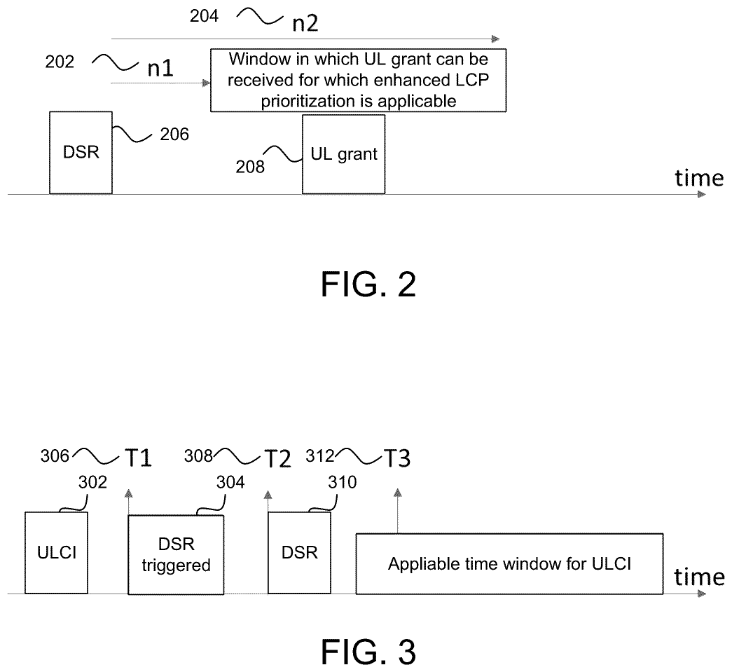

FIG. 2 illustrates an example of enhanced LCP prioritization in response to UL grants received within a time window determined based on the time DSR is sent, in accordance with aspects of the present disclosure. In one embodiment, the UE performs the enhanced LCP prioritization (i.e., prioritizing a lower priority but more delay-critical data over a higher priority, but less delay-critical data) in response to an UL grant 208 only if the grant 208 has been received at least ‘n1’ time units 202 (e.g., slots) after the time the UE has transmitted a DSR 206. In addition/alternatively, the enhanced LCP prioritization can be performed in response to an UL grant 208 only if the grant 208 has been received no later than ‘n2’ time units 204 (e.g., slots) after the time the UE has transmitted a DSR 206.

According to one implementation of the embodiment, UE applies the enhanced LCP procedure, e.g. prioritizing delay-critical data (over higher priority, but non delay-critical data) for cases when UE has not sent a buffer status report (BSR) MAC CE which contains buffer status including the higher priority data being available for transmission. In one example, UE should not apply the enhanced LCP procedure when it had already reported the higher priority data in a BSR, since gNB is aware of this higher priority data and can ensure when allocating UL resources that the delay-critical data, e.g. as reported in a DSR, can be transmitted by the UE, e.g. by allocating more UL resources.

According to one embodiment, UE triggers a BSR for cases that a DSR has been triggered, e.g. based on the DSR triggering threshold. According to one implementation of this embodiment, the UE reports a BSR MAC CE together with a DSR MAC CE when there is data pending for transmission which is of higher priority than the delay-critical data which is reported in the DSR MAC CE. In one example UE multiplexes a BSR MAC CE, e.g. refined BSR MAC CE, in a TB for cases that UE multiplexes a DSR MAC CE in a TB. In order to give gNB a comprehensive picture of UEs buffer status as well as inform gNB about delay-critical data, UE includes also a BSR MAC CE when transmitting a DSR MAC CE in a TB. The motivation for including a BSR MAC CE in addition to a DSR MAC CE is to allow gNB to make an efficient UL resource allocation, e.g. ensuring that UE can transmit the delay-critical data within its delay budget by considering potential higher priority data pending in the buffer for transmission.

According to one embodiment, UE includes higher priority data pending in the UE for transmission (data which can use allocated UL resources for transmission/retransmission) in a DSR report. According to one implementation of the embodiment, UE includes in the buffer size field in a DSR MAC CE not only the amount (e.g. in bytes) of the PDU/PDU sets for which the remaining delay is below a preconfigured threshold, but also higher priority data (data for which the remaining delay is not below the threshold) which is pending in UEs buffer for transmission.

In an example, if a LCG has data which has higher priority than the LCG (referred to as LCG1) for which DSR is triggered, the UE includes in the DSR, an indication of the buffer size for the LCG with higher priority in addition to the LCG (referred to as LCG2) for which the DSR is triggered. The UE includes the LCG-ID of LCG1 in the DSR. In a related example, the UE sends a long DSR in case LCG1 has data pending in buffer; wherein the long DSR includes buffer size for all LCGs or all LCGs which have higher priority than LCG2.

According to one embodiment, UE includes data as part of the delay-critical data reported within a DSR MAC CE for which the associated remaining delay is below a second threshold. According to one implementation of the embodiment UE triggers a DSR report for cases when the associated remaining delay of data in UE's buffer is below a preconfigured threshold, e.g. DSR triggering threshold. Since there is a reporting delay involved with the delay status reporting procedure, e.g., delay between triggering and transmission of DSR MAC CE and finally the reception of a corresponding UL Grant, UE includes all data for which the associated remaining delay is below a second configured threshold in the DSR MAC CE, e.g. the buffer size field within the DSR MAC CE contains all data for which the associated remaining delay is below a second configured threshold.

According to this embodiment, there is a difference between the DSR triggering threshold and the threshold determining the delay-critical data which is reported in a DSR. In one example the second threshold value is larger than the first threshold. In one example both thresholds are configured with the same value. Using a second threshold for the determination of the delay-critical data which is reported in a DSR MAC CE allows to also report data for which the associated remaining delay is still greater than the DSR triggering threshold but “close” to the DSR threshold. In case UE would not consider this data as delay-critical data and hence not report it, the time until the next DSR report—where this data would be eventually reported—might be so large that there is a high likelihood that the PDCP discard timer expires before gNB allocates UL resources for such data.

FIG. 3 illustrates an example of triggering DSR, in accordance with aspects of the present disclosure. As shown in FIG. 3, DSR is triggered 304 at time ‘T1’ 306 (and transmitted at time ‘T2’ 308) for an LCG due to reception of a UL cancellation indication, although the DSR 310 should have been triggered for the LCG at time ‘T3’ 312 in the absence of the UL cancellation indication 302. In one embodiment, if a UE receives an UL cancellation command (e.g., via ULCI 302 or SFI) for a first time window, if the UE has data (associated with an LCG) that its corresponding remaining delay budget is higher than the DSR triggering threshold prior to the first time window, but not after the first time window, the UE triggers the DSR prior to the first time window.

In such a case, in the DSR, the reported associated delay can be set to the DSR triggering threshold value (although the actual remaining delay budget can be larger than the DSR triggering threshold) or alternatively, there could be a state/code-point in the reported DSR indicating that the remaining delay budget is larger than that of the DSR triggering threshold.

According to one embodiment, the priority of an UL grant is determined by considering the remaining delay of the data that is multiplexed or that can be multiplexed in a MAC PDU according to the mapping restrictions. Currently the priority of an UL grant—which is used for the intra-UE prioritization scenarios with overlapping UL grants—is determined by the highest priority among the priorities of the LCH that are multiplexed or can be multiplexed in the corresponding MAC PDU.

In one embodiment, for the MAC entity configured with lch-basedPrioritization, priority of an uplink grant is determined by the highest priority among priorities of the logical channels that are multiplexed (i.e. the MAC PDU to transmit is already stored in the HARQ buffer) or have data available that can be multiplexed (i.e. the MAC PDU to transmit is not stored in the HARQ buffer) in the MAC PDU, according to mapping restrictions. The priority of an uplink grant for which no data for logical channels is multiplexed or can be multiplexed in the MAC PDU is lower than either the priority of an uplink grant for which data for any logical channels is multiplexed or can be multiplexed in the MAC PDU or the priority of the logical channel triggering an SR.

Following this rule for determining the priority of an UL grant might lead to a situation where a MAC PDU containing delay-critical data—data whose associated remaining delay is below the DSR threshold—is being deprioritized and hence not transmitted. Even though an autonomous transmission mode may be used to retransmit the deprioritized data, it might be that the autonomous transmission may only take place after the expiry of the discard time (PSDB/PDB already exceeded). Therefore, in one example, UE/MAC prioritizes an UL grant in case the smallest remaining delay of the data that is multiplexed or can be multiplexed in the corresponding MAC PDU is below a preconfigured threshold. In a further variant, the UE/MAC prioritizes an UL grant in case the smallest remaining delay of the data that is multiplexed or can be multiplexed in the corresponding MAC PDU is below a preconfigured threshold and the smallest remaining delay of the data that is or can be multiplexed in the overlapping UL grant is above a preconfigured threshold.

According to one embodiment, UE prioritizes the UL grant, which contains a DSR MAC CE for the case of overlapping UL grants. According to one implementation of the embodiment, UE multiplexes a DSR MAC CE in the prioritized UL grant. For cases when the MAC PDU has been already generated the UE should prioritize the UL grant/MAC PDU which contains a DSR MAC CE regardless of the priority of the data which is multiplexed in a MAC PDU/UL grant.

In an example, in case LCP prioritization de-prioritizes transmission of a LCH (referred to as LCH1), which will lead to having the associated remaining delay budget become less than the DSR triggering threshold (after the transmission of the prioritized transmission), a DSR is triggered for the LCH, and transmitted along with the prioritized transmission if possible.

In a related example, the UE is not expected to de-prioritize transmission of a LCH leading to its corresponding remaining delay budget becoming less than a threshold which is not greater than the DSR triggering threshold.

According to one embodiment, UE prioritizes the transmission of data with an associated remaining delay below a preconfigured threshold over MAC CEs. In one example, data of LCH(s) with a remaining delay budget (RDB) smaller than a predefined threshold are treated with higher priority than MAC CEs during the LCP procedure, e.g. multiplexed in a TB before a MAC CE.

According to one embodiment, UE sets the priority of a LCH to the highest priority, e.g. priority is equal to 1, if there is data for the LCH pending for transmission, e.g. initial transmission, for which the associated remaining delay is below a preconfigured threshold. When performing an LCP procedure to generate a TB according to allocated UL resources UE/MAC considers the priority of a LCH as the highest LCH priority, e.g. priority is equal to 1, if there is data in the LCH which can be multiplexed in the TB according to the mapping restrictions which has an associated remaining delay being below a configured threshold. In one example UE/MAC assumes that the priority of the LCH with the delay-critical data during LCP is same as the highest priority among the LCH for which data can be multiplexed into the TB.

According to one embodiment, UE considers the RDB in order to determine the priority order for the first round of the LCP procedure (satisfying the PBR) and during the second round (if there are remaining UL grant resources) UE follows the legacy procedure, i.e. in strict priority order (based on LCH priority). Considering RDB refers to when RDB of an LCG becomes smaller than a threshold, or when a DSR is triggered for the LCG or when a DSR is sent for the LCG.

In one variant of this embodiment, UE considers the RDB in order to determine the priority order for the second round of the LCP procedure (remaining UL grant resources after satisfying the PBR requirements) and during the first round UE follows the legacy procedure, i.e. based on LCH priority. LCP currently two step/round procedure—1) Satisfy PBR (up to PBR, based on LCH priority) and 2) LCH priority based.

In one embodiment, the MAC entity shall, when a new transmission is performed, allocate resources to the logical channels. In one embodiment, logical channels selected for the UL grant with Bj>0 are allocated resources in a decreasing priority order. If the PBR of a logical channel is set to infinity, the MAC entity shall allocate resources for all the data that is available for transmission on the logical channel before meeting the PBR of the lower priority logical channel(s). In one embodiment, Bj is decremented by the total size of MAC SDUs served to logical channel j above and if any resources remain, all the logical channels selected are served in a strict decreasing priority order (regardless of the value of Bj) until either the data for that logical channel or the UL grant is exhausted, whichever comes first. Logical channels configured with equal priority should be served equally. It is noted that the value of Bj can be negative.

According to one embodiment, UE considers, during LCP procedure, the remaining delay of a RLC SDU and the priority of the corresponding LCH for determining the multiplexing order. According to one implementation of the embodiment, UE/MAC forms the product of the remaining delay (in ms) and the corresponding LCH priority in order to calculate the priority of an RLC PDU/SDU. For each RLC PDU/SDU which can be multiplexed in a TB according to the multiplexing restrictions UE calculates a priority. This priority is considered when determining which data to multiplex in a TB during LCP procedure. In one example UE multiplexes the SDU/PDUs in ascending order starting with the lowest SDU/PDU priority value. In one example UE applies a two-step LCP procedure as defined in the current specifications, e.g. first round satisfying PBR requirements and second assigning remaining resources in strict priority order. In one specific implementation UE considers the RLC SDU/PDU boundaries when assigning resources to the LCHs.

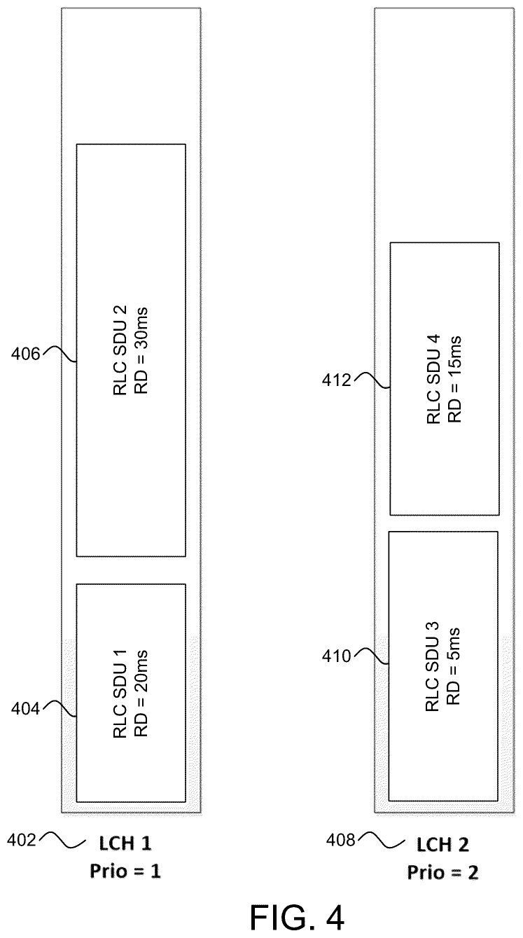

FIG. 4 illustrates an example of a UE configured with 2 LCHs, in accordance with aspects of the present disclosure. In FIG. 4, the UE is configured with 2 LCHs, LCH1 402 being the highest priority LCH (LCH priority=1). The associated RLC SDUs 404, 406 pending in the UE buffer for the 2 LCHs and their associated remaining delay (determined based on current PDCP discard timer status) is shown in the example above. RLC SDU 3 410 of LCH 2 408 is delay-critical data, but of lower priority than RLC SDUs 1 404 and 2 406 of LCH 1 402.

According to one implementation, UE calculates a priority for each RLC SDU/PDU. This priority will be the decisive factor for determining the multiplexing order. In one example the RLC SDU/PDU priority is calculated as the product of the LCH priority (associated with the SDU) and the remaining delay of the SDU. For the example above, the corresponding RLC SDU/PDU priorities would be SDU1_{Prio}=20404, SDU2_{Prio}=30 406, SDU3_{Prio}=10 410, SDU4_{Prio}=30412.

In one example, UE would use the SDU priority to determine the multiplexing order, e.g. starting with RLC SDU having the lowest value in ascending order. The resulting multiplexing order for the above example would be SDU3 410, SDU1 404, SDU2 406, SDU4 412.

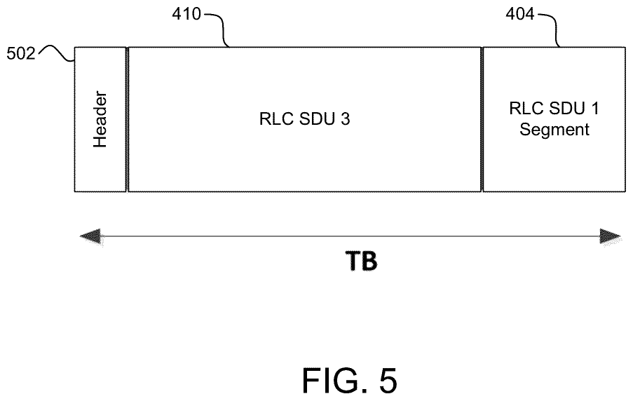

FIG. 5 illustrates an example of a multiplexed TB, in accordance with aspects of the present disclosure. The resulting multiplexing for an exemplary TB based on the RLC SDUs of FIG. 4 is shown, including a header 502, RCL SDU 3 410, and an RLC SDU 1 404 segment.

According to one implementation of this embodiment, a packet-based prioritization/multiplexing procedure is introduced, where the priority of a packet (RLC SDU/PDU) is considered, compared to the current LCH priority-based prioritization procedure.

According to one embodiment, gNB explicitly enables or disables the enhanced LCP procedure, e.g. considering the remaining delay associated with PDUs/SDUs during LCP. In one example a MAC CE is used to activate/deactivate the enhanced LCP procedure. According to another exemplary implementation of the embodiment, the DCI (e.g. UL grant) indicates whether UE should apply the enhanced LCP procedure for the corresponding UL resources allocation/PUSCH transmission.

In summary, the subject matter herein describes solutions where the UE prioritizes Delay-critical traffic over higher priority, but non-urgent traffic during LCP procedure. “Delay-critical traffic” is considered as data for which the associated remaining delay is below a preconfigured threshold.

The enhanced delay-aware LCP procedure is applied in certain predefined conditions. In response to a DSR report, UE prioritizes the delay-critical data over potential higher priority, but no urgent data. If the remaining delay associated with the delay-critical data is below a preconfigured threshold and the remaining delay associated with higher priority data is greater than another preconfigured threshold. During a defined time window, e.g. in response to having sent DSR.

In one embodiment, UE triggers a BSR when a DSR has been triggered. UE sends BSR MAC CE together with a DSR MAC CE. In one embodiment, UE includes in a DSR also higher priority data, for which the remaining delay is greater than the DSR triggering threshold. A second threshold is introduced which determines delay-critical data reported in a DSR report. This threshold might be larger than the DSR triggering threshold.

In one embodiment, the priority of an UL grant (during intra-UE prioritization) is not only defined based on highest priority data but also based on the remaining of the data associated with an UL grant. In one embodiment, the UE determines the UL grant as a prioritized UL grant if a DSR MAC CE is included in a corresponding MAC PDU.

In one embodiment, the UE maps a DSR MAC CE, if triggered, in the prioritized UL grant. In one embodiment, UE considers an UL grant as a prioritized UL grant in case there is data multiplexed in the UL grant for which the remaining delay is below a threshold.

In one embodiment, UE considers the remaining delay (RDB) in order to determine the priority order for the first round of the LCP procedure (satisfying the PBR) and during the second round (if there are remaining UL grant resources) UE follows the legacy procedure, i.e. in strict priority order (based on LCH priority).

In one embodiment, UE considers the RDB in order to determine the priority order for the second round of the LCP procedure (remaining UL grant resources after satisfying the PBR requirements) and during the first round UE follows the legacy procedure, i.e. based on LCH priority.

In one embodiment, UE considers during LCP procedure the remaining delay of a RLC SDU and the priority of the corresponding LCH for determining the multiplexing order. UE/MAC forms the product of the remaining delay (in ms) and the corresponding LCH priority in order to calculate the priority of an RLC PDU/SDU. For each RLC PDU/SDU which can be multiplexed in a TB according to the multiplexing restrictions UE calculates a priority. This priority is considered when determining which data to multiplex in a TB during LCP procedure.

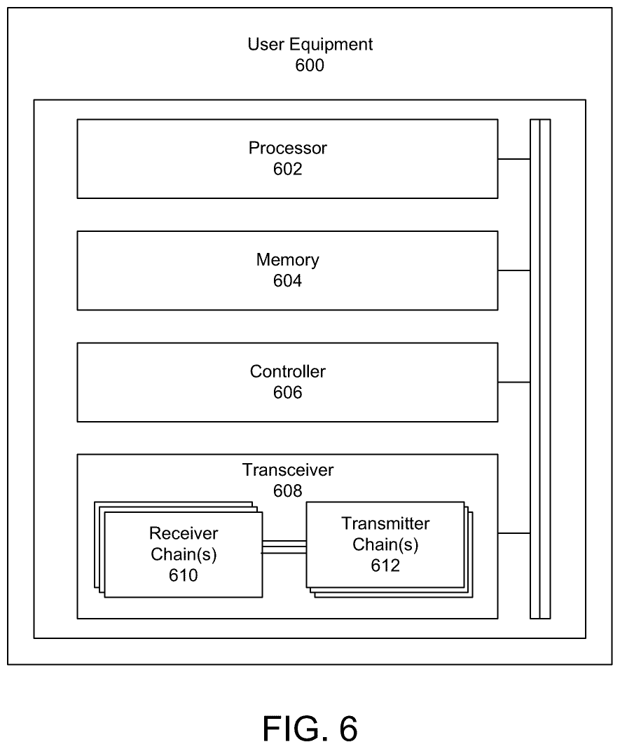

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to support a means to establish a logical channel based on a received configuration, the configuration comprising a logical channel priority for the logical channel, receive information for allocating resources for data transmission associated with the logical channel, determine a first parameter associated with data of the logical channel, and calculate a priority value for the data of the logical channel based at least in part on the first parameter and the logical channel priority in response to determining that the first parameter is below a threshold.

In one embodiment, the UE 600 may be configured to support a means to assign resources to the logical channel based at least in part on the priority value for the data. In one embodiment, the first parameter is a latency value.

In one embodiment, the first parameter is a remaining delay associated with the data of the logical channel. In one embodiment, the data of the logical channel comprises a RLC SDU. In one embodiment, the UE 600 may be configured or operable to support a means to prioritize delay-critical data over potential higher priority data in response to a DSR report.

In one embodiment, the higher priority data does not comprise delay-critical data. In one embodiment, the UE 600 may be configured or operable to support a means to prioritize delay-critical data over potential higher priority data in response to a remaining delay associated with the delay-critical data being below a first threshold and a remaining delay associated with higher priority data satisfying a second threshold.

In one embodiment, the UE 600 may be configured or operable to support a means to prioritize delay-critical data over potential higher priority data during a predefined time window.

In one embodiment, the UE 600 may be configured or operable to support a means to trigger a BSR in response to triggering of a DSR report. In one embodiment, the UE 600 may be configured or operable to support a means to include higher priority data in a DSR report in response to a remaining delay of the higher priority data not satisfying a DSR triggering threshold.

In one embodiment, the UE 600 may be configured or operable to support a means to include delay-critical data in a DSR report in response to a remaining delay of the delay-critical data satisfying a second threshold that is larger than a DSR triggering threshold.

In one embodiment, a priority of an uplink grant is determined based at least in part on highest priority data and a remaining delay of the data associated with the uplink grant. In one embodiment, the at least one processor is configured to cause the UE to consider the uplink grant as a prioritized uplink grant in response to a DSR report MAC CE being included in a corresponding MAC PDU.

In one embodiment, the UE 600 may be configured or operable to support a means to consider a remaining delay of the data of the logical channel to determine the priority order for a first round of an LCP and follow a legacy LCP during subsequent rounds of the LCP.

In one embodiment, the UE 600 may be configured or operable to support a means to consider the remaining delay of the data of the logical channel to determine the priority order for a second round of an LCP and follow a legacy LCP during a first round of the LCP.

In one embodiment, the UE 600 may be configured or operable to support a means to determine a multiplexing order for data of the logical channel based at least in part on a remaining delay of data of the logical channel and the logical channel priority of the logical channel.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receiving the signal over the air or wireless medium. The receiver chain 610 may include at least one amplifier (e.g., a low-noise amplifier (LNA)) configured to amplify the received signal. The receiver chain 610 may include at least one demodulator configured to demodulate the received signal and obtain the transmitted data by reversing the modulation technique applied during transmission of the signal. The receiver chain 610 may include at least one decoder for decoding and processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

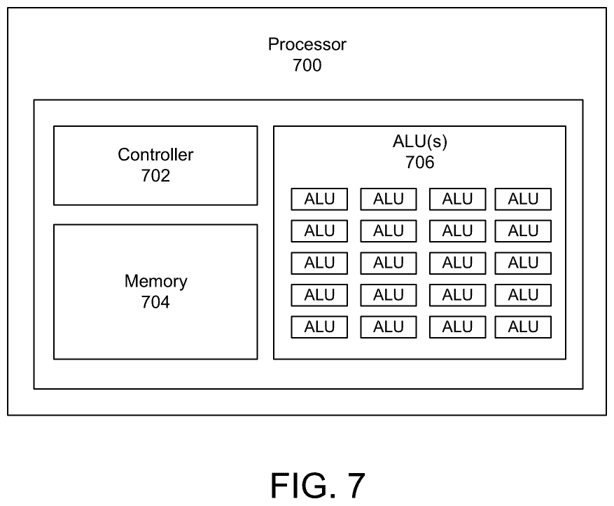

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to or operable to support a means to establish a logical channel based on a received configuration, the configuration comprising a logical channel priority for the logical channel. The processor 700 may be configured to or operable to support a means to receive information for allocating resources for data transmission associated with the logical channel, determine a first parameter associated with data of the logical channel and calculate a priority value for the data of the logical channel based at least in part on the first parameter and the logical channel priority in response to determining that the first parameter is below a threshold.

In one embodiment, the processor 700 may be configured to or operable to support a means to assign resources to the logical channel based at least in part on the priority value for the data. In one embodiment, the first parameter is a latency value.

In one embodiment, the first parameter is a remaining delay associated with the data of the logical channel. In one embodiment, the data of the logical channel comprises a RLC SDU. In one embodiment, the processor 700 may be configured to or operable to support a means to prioritize delay-critical data over potential higher priority data in response to a DSR report.

In one embodiment, the higher priority data does not comprise delay-critical data. In one embodiment, the processor 700 may be configured to or operable to support a means to prioritize delay-critical data over potential higher priority data in response to a remaining delay associated with the delay-critical data being below a first threshold and a remaining delay associated with higher priority data satisfying a second threshold.

In one embodiment, the processor 700 may be configured to or operable to support a means to prioritize delay-critical data over potential higher priority data during a predefined time window.

In one embodiment, the processor 700 may be configured to or operable to support a means to trigger a BSR in response to triggering of a DSR report. In one embodiment, the processor 700 may be configured to or operable to support a means to include higher priority data in a DSR report in response to a remaining delay of the higher priority data not satisfying a DSR triggering threshold.

In one embodiment, the processor 700 may be configured to or operable to support a means to include delay-critical data in a DSR report in response to a remaining delay of the delay-critical data satisfying a second threshold that is larger than a DSR triggering threshold.

In one embodiment, a priority of an uplink grant is determined based at least in part on highest priority data and a remaining delay of the data associated with the uplink grant. In one embodiment, the at least one processor is configured to cause the UE to consider the uplink grant as a prioritized uplink grant in response to a DSR report MAC CE being included in a corresponding MAC PDU.

In one embodiment, the processor 700 may be configured to or operable to support a means to consider a remaining delay of the data of the logical channel to determine the priority order for a first round of an LCP and follow a legacy LCP during subsequent rounds of the LCP.

In one embodiment, the processor 700 may be configured to or operable to support a means to consider the remaining delay of the data of the logical channel to determine the priority order for a second round of an LCP and follow a legacy LCP during a first round of the LCP.

In one embodiment, the processor 700 may be configured to or operable to support a means to determine a multiplexing order for data of the logical channel based at least in part on a remaining delay of data of the logical channel and the logical channel priority of the logical channel.

In one embodiment, the processor 700 is configured to determine a logical channel priority for a logical channel, transmit a configuration for establishing the logical channel with a UE, the configuration comprising the logical channel priority, and receive data on the logical channel from the UE based on the logical channel priority.

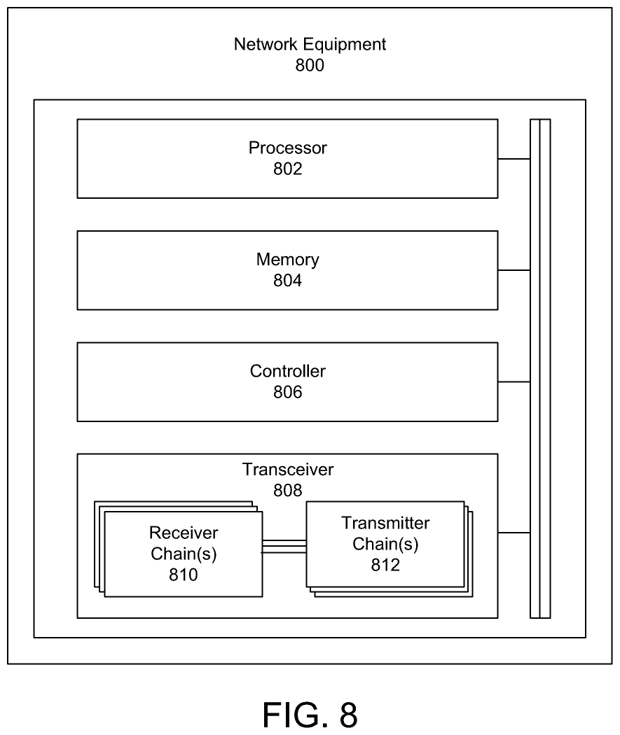

FIG. 8 illustrates an example of a NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. In one embodiment, the NE 800 is configured to determine a logical channel priority for a logical channel, transmit a configuration for establishing the logical channel with a UE, the configuration comprising the logical channel priority, and receive data on the logical channel from the UE based on the logical channel priority.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receiving the signal over the air or wireless medium. The receiver chain 810 may include at least one amplifier (e.g., a low-noise amplifier (LNA)) configured to amplify the received signal. The receiver chain 810 may include at least one demodulator configured to demodulate the received signal and obtain the transmitted data by reversing the modulation technique applied during transmission of the signal. The receiver chain 810 may include at least one decoder for decoding and processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

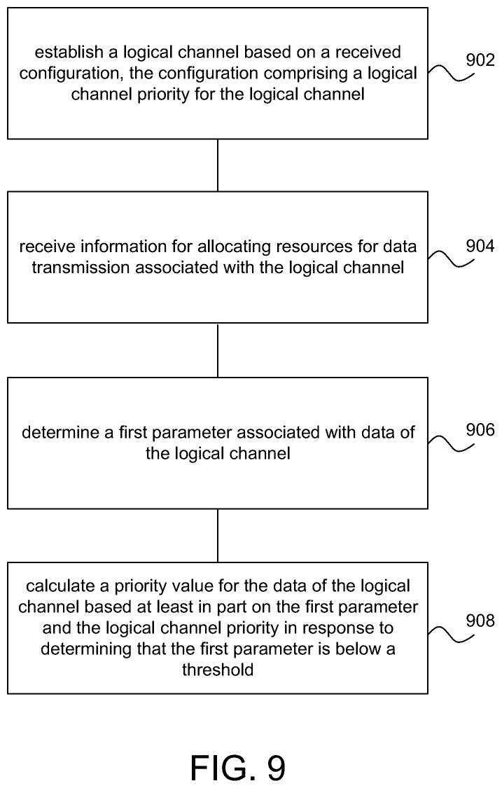

FIG. 9 illustrates a flowchart of a method in accordance with aspects of the present disclosure. The operations of the method may be implemented by a UE as described herein. In some implementations, the UE may execute a set of instructions to control the function elements of the UE to perform the described functions.

At 902, the method may establish a logical channel based on a received configuration, the configuration comprising a logical channel priority for the logical channel. The operations of 902 may be performed in accordance with examples as described herein. In some implementations, aspects of the operations of 902 may be performed by a UE as described with reference to FIG. 6.

At 904, the method may receive information for allocating resources for data transmission associated with the logical channel. The operations of 904 may be performed in accordance with examples as described herein. In some implementations, aspects of the operations of 904 may be performed by a UE as described with reference to FIG. 6.

At 906, the method may determine a first parameter associated with data of the logical channel. The operations of 906 may be performed in accordance with examples as described herein. In some implementations, aspects of the operations of 906 may be performed by a UE as described with reference to FIG. 6.

At 908, the method may calculate a priority value for the data of the logical channel based at least in part on the first parameter and the logical channel priority in response to determining that the first parameter is below a threshold. The operations of 908 may be performed in accordance with examples as described herein. In some implementations, aspects of the operations of 908 may be performed by a UE as described with reference to FIG. 6.

It should be noted that the method described herein describes a possible implementation, and that the operations and the steps may be rearranged or otherwise modified and that other implementations are possible.

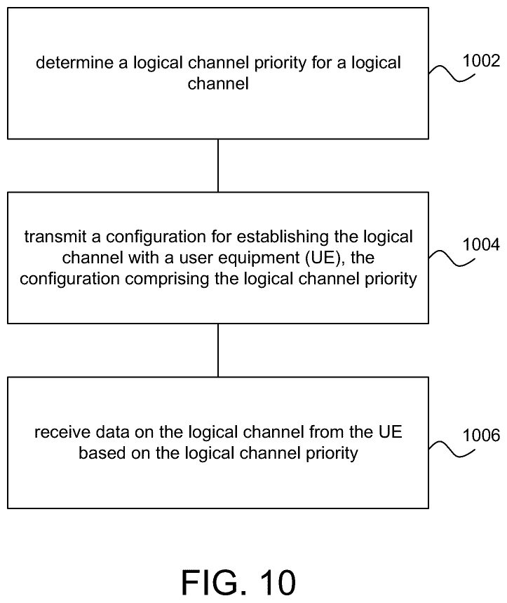

FIG. 10 illustrates a flowchart of a method in accordance with aspects of the present disclosure. The operations of the method may be implemented by a network equipment as described herein. In some implementations, the network equipment may execute a set of instructions to control the function elements of the network equipment to perform the described functions.

At 1002, the method may determine a logical channel priority for a logical channel. The operations of 1002 may be performed in accordance with examples as described herein. In some implementations, aspects of the operations of 1002 may be performed by a network equipment as described with reference to FIG. 8.

At 1004, the method may transmit a configuration for establishing the logical channel with a UE, the configuration comprising the logical channel priority. The operations of 1004 may be performed in accordance with examples as described herein. In some implementations, aspects of the operations of 1004 may be performed by a network equipment as described with reference to FIG. 8.

At 1006, the method may receive data on the logical channel from the UE based on the logical channel priority. The operations of 1006 may be performed in accordance with examples as described herein. In some implementations, aspects of the operations of 1006 may be performed by a network equipment as described with reference to FIG. 8.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
establish a logical channel based on a received configuration, the configuration comprising a logical channel priority for the logical channel;
receive information for allocating resources for data transmission associated with the logical channel;
determine a first parameter associated with data of the logical channel; and
calculate a priority value for the data of the logical channel based at least in part on the first parameter and the logical channel priority in response to determining that the first parameter is below a threshold.

2. The UE of claim 1, wherein the at least one processor is configured to cause the UE to assign resources to the logical channel based at least in part on the priority value for the data.

3. The UE of claim 1, wherein the first parameter is a latency value.

4. The UE of claim 3, wherein the first parameter is a remaining delay associated with the data of the logical channel.

5. The UE of claim 1, wherein the data of the logical channel comprises a radio link control (RLC) service data unit (SDU).

6. The UE of claim 1, wherein the at least one processor is configured to cause the UE to prioritize delay-critical data over potential higher priority data in response to a delay status reporting (DSR) report.

7. The UE of claim 6, wherein the higher priority data does not comprise delay-critical data.

8. The UE of claim 1, wherein the at least one processor is configured to cause the UE to prioritize delay-critical data over potential higher priority data in response to a remaining delay associated with the delay-critical data being below a first threshold and a remaining delay associated with higher priority data satisfying a second threshold.

9. The UE of claim 1, wherein the at least one processor is configured to cause the UE to prioritize delay-critical data over potential higher priority data during a predefined time window.

10. The UE of claim 1, wherein the at least one processor is configured to cause the UE to trigger a buffer status report (BSR) in response to triggering of a delay status reporting (DSR) report.

11. The UE of claim 1, wherein the at least one processor is configured to cause the UE to include higher priority data in a delay status reporting (DSR) report in response to a remaining delay of the higher priority data not satisfying a DSR triggering threshold.

12. The UE of claim 1, wherein the at least one processor is configured to cause the UE to include delay-critical data in a delay status reporting (DSR) report in response to a remaining delay of the delay-critical data satisfying a second threshold that is larger than a DSR triggering threshold.

13. The UE of claim 1, wherein a priority of an uplink grant is determined based at least in part on highest priority data and a remaining delay of the data associated with the uplink grant.

14. The UE of claim 13, wherein the at least one processor is configured to cause the UE to consider the uplink grant as a prioritized uplink grant in response to a delay status reporting (DSR) report medium access control (MAC) control element (CE) being included in a corresponding MAC packet data unit (PDU).

15. The UE of claim 1, wherein the at least one processor is configured to cause the UE to consider a remaining delay of the data of the logical channel to determine the priority order for a first round of a logical channel procedure (LCP) and follow a legacy LCP during subsequent rounds of the LCP.

16. The UE of claim 1, wherein the at least one processor is configured to cause the UE to consider the remaining delay of the data of the logical channel to determine the priority order for a second round of a logical channel procedure (LCP) and follow a legacy LCP during a first round of the LCP.

17. The UE of claim 1, wherein the at least one processor is configured to cause the UE to determine a multiplexing order for data of the logical channel based at least in part on a remaining delay of data of the logical channel and the logical channel priority of the logical channel.

18. A processor for wireless communication, comprising:
at least one controller coupled with at least one memory and configured to cause the processor to:
establish a logical channel based on a received configuration, the configuration comprising a logical channel priority for the logical channel;
receive information for allocating resources for data transmission associated with the logical channel;
determine a first parameter associated with data of the logical channel; and
calculate a priority value for the data of the logical channel based at least in part on the first parameter and the logical channel priority in response to determining that the first parameter is below a threshold.

19. A method performed by a user equipment (UE), the method comprising:
establishing a logical channel based on a received configuration, the configuration comprising a logical channel priority for the logical channel;
receiving information for allocating resources for data transmission associated with the logical channel;
determining a first parameter associated with data of the logical channel; and
calculating a priority value for the data of the logical channel based at least in part on the first parameter and the logical channel priority in response to determining that the first parameter is below a threshold.

20. A network equipment for wireless communication, comprising:
at least one memory; and
at least one processor coupled with the at least one memory and configured to cause the network equipment to:
determine a logical channel priority for a logical channel;
transmit a configuration for establishing the logical channel with a user equipment (UE), the configuration comprising the logical channel priority; and
receive data on the logical channel from the UE based on the logical channel priority.
